(19) United States
(12) Patent Application Publication
(10) Pub. No.: US 2007/0298181 A1
(43) Pub. Date: Dec. 27, 2007

(54) Method of Transferring and Liquid Coating Apparatus

(76) Inventors: Tamao Kojima, Osaka (JP); Hiroki Nunose, Nara (JP)

Correspondence Address: WENDEROTH, LIND & PONACK L.L.P., 2033 K. STREET, NW, SUITE 800, WASHINGTON, DC, 20006, US

(21) Appl. No.: 11/792,533

(22) PCT Filed: Oct. 12, 2005
(86) PCT No.: PCT/JP05/18801

§ 371 Date: Jun. 7, 2007

(30) Foreign Application Priority Data
Dec. 9, 2004 (JP) 2004-356677

(51) Int. Cl. B44C 1/175; B05C 11/00; B05C 5/00; B05D 3/00

(52) U.S. Cl. 427/401; 118/75

(57) ABSTRACT

To obtain a coating film which has an enhanced adhesion and image clarity of the transferred coating film and is free from external defects such as a foreign matter defect, a surface rupture, and breaking and distortion of print pattern, etc.

A transfer method including the steps of floating a transfer sheet 101 on the water surface of a transfer bath 11, coating an activator 14 onto the transfer sheet 101, immersing a transfer target 15 into the transfer bath from above the transfer sheet 101 to transfer the transfer sheet thereon, and after washing away the base material 102 with water, drying the transfer target 15 onto which the coating film 105 has been transferred so as to cure the coating film 105, wherein in the step of coating an activator onto the transfer sheet to activate the same, a pressure of not less than 0.008 MPa and not more than 0.040 Mpa is applied to the nozzle head 3 which includes a plurality of nozzles to eject the activator and the nozzle head 3 is moved above the transfer sheet 101.

### TECHNICAL FIELD

The present invention relates to a transfer method for forming a coating film layer on the surface of various formed bodies and the like by transfer utilizing liquid pressure, and a liquid coating apparatus used therefor.

### BACKGROUND ART

As a conventional transfer method, there has been proposed a transfer method by liquid pressure, including the steps of: floating on the water surface a transfer sheet which includes a water soluble film and a coating film layer formed thereon, to is dissolve or swell the water soluble film; coating an activator onto the transfer sheet to activate the same; immersing a transfer target into a transfer bath from above the transfer sheet to transfer the transfer sheet; washing away the water soluble film with water; drying the transfer target to which the coating film has been transferred; and curing the coating film which has been transferred to the transfer target (for example, see Patent Reference 1).

Further, as a coating method for an activator, there has been proposed a method of coating an activator onto a transfer sheet in which a nozzle head is moved above the transfer sheet while forcing the activator flowing down in a brush-like form from the nozzle head having multiple nozzles by applying an air pressure of 0.05 to 0.2 MPa (see Patent Reference 2). Such an activator coating method exhibits high permeability of the activator into the coating film layer compared with a method using a spray nozzle or supersonic nozzle in which an activator is coated in an atomized state. Accordingly, a uniform dissolution will take place throughout the thickness of the coating film layer, and thereby a transfer-coating film with high image clarity is achieved.

Further, as a countermeasure against breaks or distortions of print pattern which are generated when the coating film layer dissolves after the activator is coated and the transfer sheet spreads on the water surface, there has been proposed a method of restricting the transfer sheet from being spread by providing a frame body in the outer periphery of the transfer sheet floating on the water surface (see, for example, Patent Reference 2).

On the other hand, for coating an activator, the activator preferably does not contain air bubbles, and also there is a need of suppressing activator consumption to a minimum.

As a conventional method of coating a liquid (activator) without containing air bubbles, or a method of reducing the consumption of liquid other than for coating, there has been a method of discharging the air bubbles in a nozzle head or in an ejection port together with liquid by supplying a pressurized liquid to the nozzle head and purging it, or a method of returning the air bubbles contained in a supply circuit of liquid to a storage tank together with liquid through a discharge circuit which does not pass through the nozzle head.

As a conventional art of this type, there is a technique described in Patent Reference 3. FIG. 1 is a block diagram to show a conventional coating apparatus according to Patent Reference 3, in which numerals 11, 12, 13, and 14 denote a head unit respectively, numerals 21, 22, 23, and 24 denote a supply passage respectively corresponding to each head unit 11 to 14, numerals 31, 32, 33, and 34 denote a discharge passage and, in a like manner, 41 a first valve, 42 a second valve, 51 a circulation outward passage, 52 a circulation return passage, 53 an activator tank, 54 a sub tank, and 55 an air pump.

As with the activator jet nozzle disclosed in Patent Reference 3, there are provided a supply tank for supplying liquid (an activator tank 53), a supply circuit for connecting the supply tank and the nozzle head (head unit 11, 12, 13, 14), a discharge circuit for connecting the nozzle head and a storage tank (a sub tank 54), and a change valve (second valve 42) between the discharge circuit and the storage tank, and there are further provided a direct-connection circuit which consists of a supply circuit and a discharge circuit and which does not pass through the nozzle head, and a change valve (first valve 41) interposed in the direct-connection circuit.

In this way, firstly with the change valve of the direct-connection circuit being closed and the change valve of the discharge circuit being opened, liquid is supplied from the supply tank so that air bubbles in the nozzle head are recovered together with liquid to be retained in the storage tank. Thereafter, by opening the change valve of the direct-connection circuit, the air bubbles in the direct-connection circuit are recovered together with liquid to be retained in the storage tank. Further, by closing the change valve of the direct-connection circuit and the change valve of the discharge circuit, the activator is purged from the nozzle head thereby discharging the air bubbles in the nozzle head.

In FIG. 1, the supply tank is to pump ink to the nozzle head and the direct-connection circuit. The storage tank retains the ink pumped from the nozzle head or the direct-connection circuit. The change valves provided in the supply tank, in the direct-connection circuit, and between the supply tank and the storage tank combine their switching actions to force the activator, which has been pumped from the supply tank, to pass through the nozzle head, the discharge circuit, the direct-connection circuit etc. thereby discharging the air contained therein or purging it from the nozzle head.
Patent Reference 1: Japanese Laid-Open Patent Application No. 01-22378
Patent Reference 2: Japanese Laid-Open Patent Application No. 2003-236422
Patent Reference 3: Japanese Laid-Open Patent Application No. 11-342634

### DISCLOSURE OF INVENTION

Problems that Invention is to Solve

However, in the transfer method by liquid pressure according to the conventional configuration described in the former part of the previous section, since the transfer sheet is left standing in an exposed state for extended hours in the step of dissolving or swelling a water soluble film, it is likely that dust or dirt is deposited on the transfer sheet during this period thereby causing a foreign matter defect. Further, in the step of coating an activator on to the transfer sheet to activate the same, the transfer sheet is left standing in an exposed state for extended hours, it is also likely that dust or dirt is deposited on the transfer sheet during this period thereby causing a foreign matter defect. As a method of preventing such foreign matter defect, it is considered to be effective to perform the transfer operation in a large-scale clean room, but a problem will arise in the construction cost or maintenance work.

Further, if clean air or the like is blew down on the transfer sheet after an activator is coated thereon, the activator on the transfer sheet will vaporize thereby bringing the surface of the transfer sheet into a dry state and thereby the adhesion and image clarity of the transfer-coating film will be degraded. Further, there is another problem in that since the coating film layer in a non-cured state has a low elasticity, the surface of the coating film layer may be damaged by a high liquid pressure portion, which is generated due to the variation in the spouting quantity of a shower nozzle when it is used in washing away the water soluble film, thereby causing degradation of image clarity.

Further, in the method of coating an activator according to the conventional configuration described above, since the activator is subjected to a high pressure and thereby the transfer sheet may be partially broken, it is necessary to restore the surface protection layer by for example a painting process. Further, in the method of preventing breaks or distortions of the print pattern according to the conventional configuration, there is a problem that since the transfer sheet tends to adhere to the frame body provided in the outer periphery of the transfer sheet, the maintenance work for the frame body becomes necessary each time for a continuous use.

On the other hand, in the conventional configuration described in the latter part of the previous section, when with the change valve of the direct-connection circuit being closed and the change valve of the discharge circuit being opened, the activator in the direct-connection circuit is discharged by opening the change valve of the direct-connection circuit after the air bubbles in the nozzle head are discharged by pumping the activator from the supply tank, air bubbles associated with the reduced pressure will be generated in the nozzle head circuit since the flow resistance in the nozzle head is larger than that in the direct-connection circuit.

Further, in the above described conventional method of preventing air-bubble generation by purging, when liquid is coated again after the air bubble in the nozzle head is discharged by purging, due to the reduced pressure in association with the deactivation of the pump or the reduced pressure due to a high flow velocity at the nozzle opening, the air is suctioned through a nozzle opening upon deactivating the air pump thereby generating air bubbles.

Thus, there is a problem that air bubbles cannot be eliminated.

Further, in the conventional method of preventing air-bubble generation, purging is of necessity and therefore there is a problem that an extra amount of activator other than actually used for printing is needed.

The present invention aims at solving the above described problems in the conventional arts, and it is the first object of the present invention to provide a transfer method by liquid pressure: which can achieve a coating film having high adhesion and image clarity, being free from external defects such as a foreign matter defect, a surface rupture, a break of print pattern, and a distortion of print pattern, and having a high aesthetic quality; which does not require the step of restoring the surface protection layer by for example a painting process; and in which a frame body is not needed in the step of activating the transfer sheet.

Further, it is the second object of the present invention to provide coating of a liquid containing no air bubble through the prevention of air-bubble generation in the nozzle head by avoiding a decrease of the nozzle internal pressure from the start point of discharging the air bubbles in the nozzle head until the completion of coating; and also to do away with the purging operation thereby eliminating the need of liquid other than used for coating.

Means to Solve the Problems

In order to achieve the above-mentioned object, the transfer method according to the present invention is a transfer method including: a step of floating a transfer sheet on a water surface of a transfer bath so as to swell the transfer sheet, the transfer sheet having a base material layer and a coating film layer; a step of coating an activator onto the transfer sheet to activate the transfer sheet; a step of immersing a transfer target into the transfer bath from above the transfer sheet to transfer the transfer sheet; a step of washing away the base material layer with water; a step of drying the transfer target onto which the coating film has been transferred; and a step of curing the coating film which has been transferred onto the transfer target, wherein the step of coating an activator onto the transfer sheet to activate the transfer sheet includes a step of coating the activator onto the transfer sheet by ejecting the activator from a nozzle head having multiple nozzles and moving the nozzle head above the transfer sheet, the activator being pumped at a pressure of not less than 0.008 MPa and not more than 0.040 Mpa.

Accordingly, it becomes possible to achieve a liquid pressure-transferred transfer-coating film having no surface rupture, without the need for a restoration step such as by a painting process.

Furthermore, it is also possible that the step of floating a transfer sheet on a water surface of a transfer bath to swell the transfer sheet includes a step of placing a cover above the transfer sheet after floating the transfer sheet on the water surface of the transfer bath. Accordingly, it becomes possible to restrict dust or dirt from being deposited on the transfer sheet and thereby prevent foreign matter defects, and to restrict the generation of distortions of the print pattern.

Furthermore, it is also possible that the transfer method further includes: a step of pumping the activator at a pressure lower than the pressure in the step of coating the activator, and discharging air from the nozzle head before the step of coating the activator; and a step of recovering the activator used in the step of discharging the air, and conveying the activator to the supply tank.

Accordingly, it becomes possible to restrict air bubbles from being mixed into the activator to be coated, and achieve a satisfactory transfer in which foreign matter defects etc. are prevented. Further, it is also becomes possible to suppress activator consumption.

Furthermore, it is also possible that the step of coating an activator onto the transfer sheet includes a step of coating the activator onto the inner part of the transfer sheet excepting a peripheral edge of the transfer sheet.

Accordingly, it becomes possible to inhibit the phenomenon where the coating film layer dissolves after the coating of the activator and the transfer sheet spreads on the water surface, and to prevent the generation of breaks or distortions of print pattern without using a frame body in the step of activating the transfer sheet.

Furthermore, in order to achieve the above-mentioned object, the liquid coating apparatus used in a transfer method according to the present invention includes: a nozzle head provided with a plurality of nozzles; a through passage provided inside the nozzle head and through which liquid is passed; a supply tank for holding liquid to be pumped; a storage tank for storing the liquid which has passed through the through passage; a first open-close valve provided in a first flow passage which connects the supply tank and the nozzles; a second open-close valve provided in a second flow passage which connects the storage tank and the nozzles; and a third open-close valve provided in a third flow passage which connects the storage tank and the supply tank, wherein units of the nozzles, the supply tank, and the storage tank are connected to form a closed flow passage, the nozzle head being provided with the plurality of nozzles each of which has a pore depth of not less than 0.05 mm and not more than 0.3 mm, and a pore diameter of not less than 0.02 mm and not more than 0.15 mm.

Accordingly, it becomes possible to implement a coating in which liquid dripping is suppressed to a minimum, and using this apparatus in a transfer method can contribute to the prevention of transfer defects such as a foreign matter defect. Furthermore, it is possible that the nozzle head includes a through passage which is connected with the nozzles and is provided with an ejection port other than the nozzles.

By using the above described through passage, it becomes possible to discharge the air in the nozzle head and thus coating an activator having minimized air bubble content becomes possible.

Furthermore, it is possible that the liquid coating apparatus includes: a supply tank for holding liquid to be pumped; a storage tank for storing the liquid which has passed the ejection port of the through passage; and a connecting passage for conveying liquid from the supply tank to the storage tank.

Accordingly, it becomes possible to suppress activator consumption even when the air in the nozzle head is discharged.

Furthermore, it is possible that the liquid coating apparatus further includes a moving mechanism for moving the nozzle head and a transfer sheet relative to each other.

Accordingly, it becomes possible to perform uniform coating in a stable manner.

Effects of the Invention

As so far described, the present invention, which makes it possible to achieve a coating film that has an enhanced adhesion and image clarity, is free from external defects such as a foreign matter defect, a surface rupture, a breaking of print pattern, and a distortion of print pattern, and has a high aesthetic quality, has advantages in that there is no restoration step for the surface protection layer by for example a painting process, and generation of breaks or distortions of print pattern can be prevented without the need of a frame body in the step of activating the transfer sheet.

### BRIEF DESCRIPTION OF DRAWINGS

FIG. 1 is a block diagram showing a conventional coating apparatus.

FIG. 2 shows a liquid circulation circuit diagram of a liquid coating apparatus.

FIG. 3 is a sectional view showing a nozzle head 3 together with a transfer bath in a liquid coating apparatus.

FIG. 4 is a sectional view showing a transfer sheet.

FIG. 5 is a flow chart showing the processing procedures of a transfer method.

FIG. 6 shows the first step for coating an activator using the liquid coating apparatus.

FIG. 7 shows the second step for coating an activator using the liquid coating apparatus.

FIG. 8 shows the third step following the aforementioned second step.

FIG. 9 conceptually shows the processing procedures of a transfer method.

FIG. 10 conceptually shows the processing procedures of a transfer method as a comparative example.

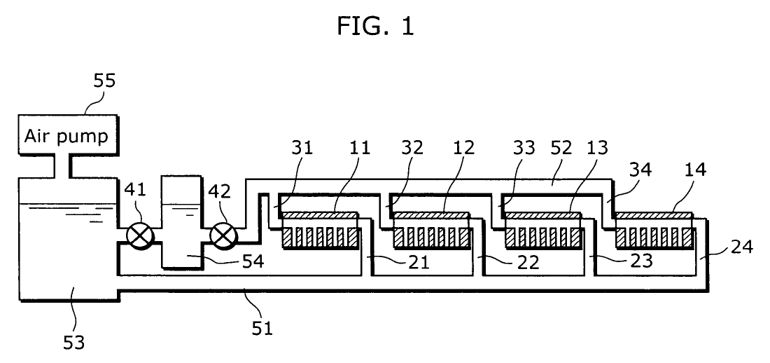

### NUMERICAL REFERENCES

1 Supply tank
2 First open-close valve
3 Nozzle head
4 Second open-close valve
5 Storage tank
6 Third open-close valve
7 Connecting tube
9 First tube
10 Second tube
11 Transfer bath
12 Cover
13 Spray nozzle
14 Activator
15 Transfer target object
16 Slit nozzle
17 Fresh water
18 Liquid-pressure transfer plate
22 Through passage
23 Through hole
24 Nozzle plate
25 Nozzle
26 Packing
30 Liquid coating apparatus
31 Rail
32 Pressurizing circuit
33 First air valve
34 Second air valve
35 Compressed air source
101 Transfer sheet
102 Base material
103 Surface protection layer
104 Color layer
105 Coating film
W Water

### BEST MODE FOR CARRYING OUT THE INVENTION

Hereinafter, the embodiments of the present invention will be described in detail with reference to the drawings.

First, the liquid coating apparatus 30 used in the transfer method according to the present invention will be described.

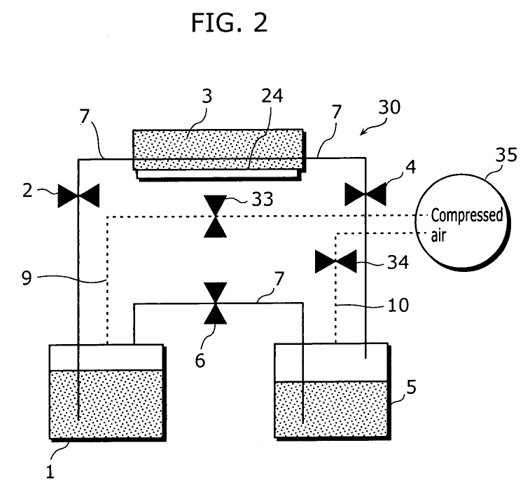

FIG. 2 is a liquid circulation circuit diagram of the liquid coating apparatus 30.

As shown in the figure, the liquid coating apparatus 30 includes a supply tank 1, a first open-close valve 2, a nozzle head 3, a second open-close valve 4, a storage tank 5, a third open-close valve 6, and a connecting tube 7 for connecting the aforementioned elements. Further, each of the aforementioned elements is connected so as to constitute a closed liquid circulation circuit for conveying liquid from the supply tank 1 to forward it from the storage tank 5.

Furthermore, the liquid coating apparatus 30 further includes a compressed air source 35, a first tube 9, a second tube 10, a first air valve 33, and a second air valve 34. These elements constitute a pressurizing circuit for supplying compressed air to the supply tank 1 or the storage tank 5.

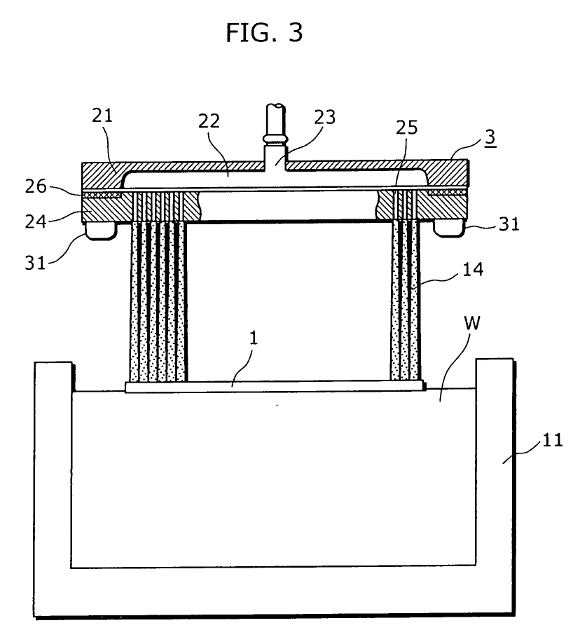

The nozzle head 3 includes a through passage 22 through which liquid passes (see FIG. 3) and a nozzle plate 24 having two or more micro pores (nozzle 25) which are connected with the through passage 22. The nozzle head 3 constitutes a nozzle unit for coating a liquid.

The supply tank 1, which is connected with the first tube 9 through which compressed air is supplied, is adapted to be able to pump liquid via the connecting tube 7.

The storage tank 5, which is connected with the second tube 10 through which compressed air is supplied, is adapted to be able to pump liquid via the connecting tube 7.

FIG. 3 is a cross sectional view showing the nozzle head 3 together with a transfer chamber in the liquid coating apparatus 30.

As shown in the figure, the nozzle head 3 includes a nozzle block 21 provided with a through passage 22 having a concave inner surface, a nozzle plate 24 provided with a nozzle 25 which consists of multiple micro pores, and a packing 26 which seals the space between the peripheries of the nozzle block 21 and the nozzle plate 24 so that liquid will not leak out from the secured portion when the nozzle block 21 and the nozzle plate 24 are superposed and secured such that the through passage 22 of the nozzle block 21 and the nozzle 25 of the nozzle plate 24 are connected.

In the nozzle block 21, a through hole 23 is provided which vertically penetrates the nozzle block 21 and is connected with the through passage 22. Further the nozzle block 21 is provided with an ejection hole not shown. This ejection hole can eject a large volume of activator which is pumped from the through hole 23 to the through passage 22. This ejection hole is connected with the storage tank 5 via the connecting tube 7.

Further, the nozzle head 3 is placed on and slidably held by a rail 31, and is adapted to be movable above the transfer bath 11 by means of a positionable single-axis slide.

To be more specific, the nozzles 25, that is, the pores provided in the nozzle plate 24 in such a way as to penetrate therethrough are set to have a pore depth of not less than 0.05 mm and not more than 0.3 mm, and a pore diameter of not less than 0.02 mm and not more than 0.15 mm. The reason is as follows: when the pore depth is less than 0.05 mm, dripping of the activator will take place, and when it is more than 0.3 mm, the variation in the spouting quantity will become larger. Moreover, when the pore diameter is less than 0.02 mm, the variation in the spouting quantity will become larger, and when it is more than 0.15 mm, dripping of the activator will take place.

Furthermore, the nozzle plate 24 is provided with approximately 600 of nozzles 25 on a straight line, and the spacing between the nozzles 25 is set to be approximately 0.5 mm. This makes it possible to coat the activator onto the width of about 300 mm.

On the other hand, the transfer bath 11 is a tub capable of storing water, and inside of which water W is stored.

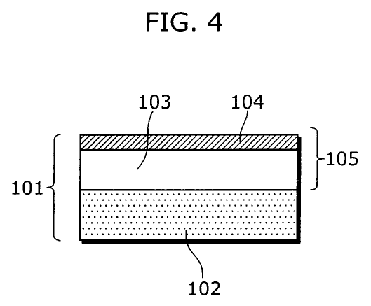

FIG. 4 is a sectional view of a transfer sheet 101 to be used in the transfer method according to the present embodiment.

As shown in the figure, the transfer sheet 101 includes a base material 102 made up of a water soluble or water swellable film, and a coating film layer 105, with the base material 102 and the coating film layer 105 being bonded together in a laminar fashion. Moreover, the coating film layer 105 further includes a surface protection layer 103 and a color layer 104, and the surface protection layer 103 and the color layer 104 are bonded together in a laminar fashion such that the color layer 104 is exposed at the surface of the transfer sheet 101.

Then, the color layer 104 with an abstract print pattern is printed on the surface of the surface protection layer 103 to form a coating film layer 105, thereby obtaining a transfer sheet 101 in which the coating film layer 105 is made up of an ionizing radiation curable resin.

The coating film layer 105 preferably consists of the color layer 104 and the surface protection layer 103. With such configuration, the color layer 104 and the surface protection layer 103 can be transferred in one operation, thereby eliminating the need of a painting process for forming the surface protection layer 103.

(Embodiment 1)

Next, embodiment 1 of the transfer method according to the present invention will be described.

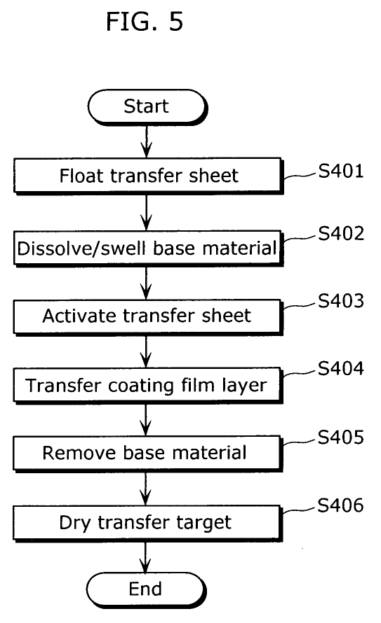

FIG. 5 is a flow chart showing the processing procedures of the transfer method.

The first transfer method by liquid pressure according to the present embodiment will be briefly described as follows. That is, the transfer sheet 101 made up of a base material 102 and a coating film layer 105 is floated on the water surface of a transfer bath 11 (S401); the base material 102 is dissolved or swelled (S402); the transfer sheet 101 is activated by coating activator onto the transfer sheet 101 (S403); a transfer target is immersed into a transfer bath from above the transfer sheet 101 so that the coating film layer 105 is transferred to the transfer target (S404); the base material 102 is washed away with water (S405); and the transfer target onto which the coating film layer 105 has been transferred is dried to cure the coating film which has been transferred to the transfer target (S406). This will complete the whole transfer processing.

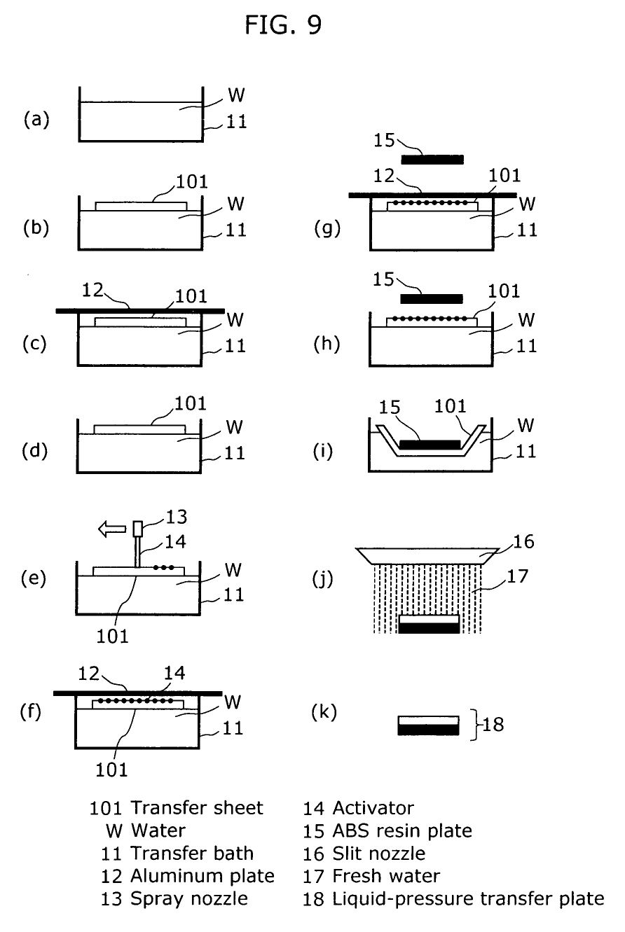

In this embodiment, after the processing of floating the transfer sheet 101 on the water surface of the transfer bath 11 (S401), a cover 12 (see FIG. 9) is placed on the transfer bath 11 in order to protect the transfer sheet 101.

As the method of placing the cover 12 on the transfer bath 11, besides the method of moving the cover 12 by manual operation or by using a horizontally moving robot, a method may be used in which the cover 12 is placed in advance on any part above the transfer bath, and after the transfer sheet is floated on the water surface of the transfer bath, it may be moved underneath the cover 12 covering a part of the transfer bath 11 by means of water flow etc.

The shape of the cover 12 may be, without limitation, any of a plate form, a film form, and a block form. Moreover, the material for use in the cover 12 may be, without limitation, metal, resin, ceramics, paper, or a compound containing at least one of these.

The distance between the transfer sheet 101 and the cover 12 is preferably not less than 3 mm and not more than 50 mm. This is because when the distance between the transfer sheet 101 and the cover 12 is less than 3 mm, there is a risk that the transfer sheet 101 may contact the cover 12. Also, when it is more than 50 mm, the effect of preventing foreign matter defects may be degraded.

Further, according to the present embodiment, in the step of coating an activator onto the transfer sheet 101 and activating the same (S403), the cover 12 is placed above the transfer sheet 101 and at the opening of the transfer bath 11 even after the activator is coated onto the transfer sheet 101.

The method of placing the cover 12, and the shape and material of the cover 12 may be or may not be the same as the method of placing the cover 12, and the shape and material of the cover 12 which are adopted after the aforementioned transfer sheet 101 is floated on the water surface of the transfer bath 11.

It is the same as described above that when the distance between the transfer sheet 101 and the cover 12 is less than 3 mm, there is risk of contact between the transfer sheet 101 and the cover 12, and when it is more than 50 mm, the effect of preventing foreign matter defects will be degraded. Furthermore, since when the distance between the transfer sheet 101 and the cover 12 is more than 10 mm, the effect of restricting the evaporation of the solvent will be degraded, the distance between the transfer sheet 101 and the cover 12 is preferably not less than 3 mm and not more than 50 mm, and more preferably not less than 3 mm and not more than 10 mm.

Further, according to the present embodiment, in the step of washing away the base material 102 with water (S405), the kinetic energy of the water which hits the surface of the transfer target is set to be not more than 0.68 kg·m²/s². When the kinetic energy of the water which hits the surface of the transfer target becomes more than 0.68 kg·m²/s², a surface damage of the coating film layer 105 will take place due to the water pressure thereby degrading image clarity.

Furthermore, the step of washing away the base material 102 with water (S405) is carried out by forcing the water to spout from a slit nozzle. The slit width of the slit nozzle is preferably not less than 0.1 mm and not more than 1.0 mm. When the slit width becomes less than 0.1 mm, variation in the spouting quantity of water is likely to take place, and when it becomes more than 1.0 mm, the amount of water increases and the coating film surface is more likely to be damaged.

By adopting the above described transfer method and employing the above described liquid coating apparatus 30 in the predetermined steps, it is made possible to enhance the adhesion and image clarity of the transfer-coating film and restrict the generation of exterior defects such as a foreign matter defect, a surface rupture, a break in print pattern, a distortion of print pattern, etc to a minimum. Thus, it is made possible to achieve a transfer target having a high aesthetic quality.

Moreover, the present embodiment offers advantages that there is no restoration step of the surface protection layer by for example a painting process, and the generation of breaks or distortions of print pattern can be prevented without need of a frame body in the step of activating the transfer sheet.

Furthermore, owing to the prevention of foreign matter defects by placing the cover 12 above the transfer sheet in the step (S402) of floating the transfer sheet 101 on the water surface of the transfer bath 11 and dissolving or swelling the base material 102 to remove it; and the surface protection layer 103 provided in the coating film layer 105, a color layer and a surface protection layer are formed on the surface of the transfer target without a painting process.

Furthermore, the coating film layer 105 is preferably made up of an ionizing radiation curable resin. When using a thermosetting resin, generally the curing temperature is set above the softening temperature of the coating film, and therefore the coating film is softened in the curing step causing the adhesion of dust or dirt onto the surface of the coating film layer resulting in the foreign matter defects. In contrast, when using an ionizing radiation curable resin, since the softening of the coating film hardly occurs in the curing step and besides the curing time is relatively short, foreign matter defects are less likely to take place.

Further, according to the present embodiment, the opening of the transfer bath 11 is covered with the cover 12 to cover the transfer sheet 101, but the position of the cover 12 for covering the transfer sheet 101 is not limited provided that it is within the aforementioned limit of the distance.

(Embodiment 2)

Next, the transfer method according to another embodiment will be described.

The general steps of the transfer method according to the present embodiment are approximately the same as those of the above described embodiment; in which as shown in FIG. 5, the transfer sheet 101 made up of a base material 102 and a coating film layer 105 is floated on the water surface of the transfer bath 11 (S401); the base material 102 is dissolved or swelled (S402); an activator is coated onto the transfer sheet 101 to activate the transfer sheet 101 (S403); a transfer target is immersed into the transfer bath from above the transfer sheet 101 to transfer the coating film layer 105 onto the transfer target (S404); the base material 102 is washed away (S405) with water; and the transfer target onto which the coating film layer 105 has been transferred is dried to cure the coating film which has been transferred onto the transfer target (S406). This will complete the whole transfer processing.

Now, the activation step (S403) of the transfer sheet 101 according to the present embodiment will be described in detail.

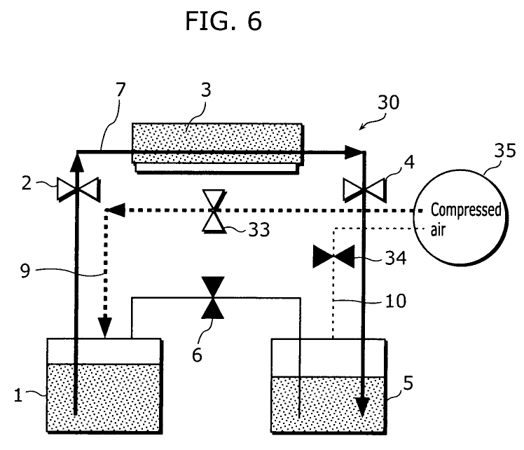

FIGS. 6 to 8 show the coating steps of the activator in the liquid coating apparatus 30 for use in the activation step (S403) of the transfer sheet 101. Moreover, in those figures, as to the first open-close valve 2, the second open-close valve 4, and the third open-close valve 6, a valve in an open state is indicated by a white color and a valve in a closed state is indicated by a black color.

FIG. 6 shows the first step of coating an activator using the liquid coating apparatus 30. As shown in the figure, the first open-close valve and the second open-close valve are opened. In is this state, a low pressure compressed air is being conveyed from the compressed air source 35 to the supply tank 1 via the opened first air valve 33 and the first tube 9.

As described so far, the activator in the supply tank 1 is conveyed to the storage tank 5 passing through the connecting tube 7, the first open-close valve 2, the through passage 22 in the nozzle head 3, and the connecting tube 7 in this order. As the result, air bubbles contained in the connecting tube 7, the through passage 22 of the nozzle head 3, etc. are conveyed with liquid to the storage tank 5, thus making it possible to create a state in which the connecting tube 7 and the nozzle head 3 are filled with the activator containing no air bubble.

Moreover, in this first step, since the compressed air is at a low pressure, the flowout of the activator from the nozzle 25 is restricted.

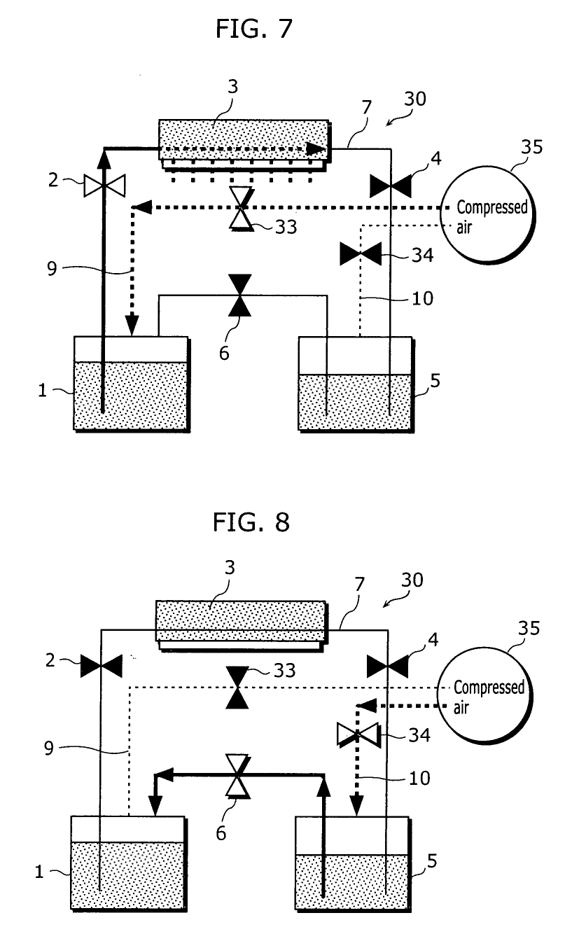

FIG. 7 shows the second step of coating the activator using the liquid coating apparatus 30. Following the first step, the second open-close valve 4 is closed and the compressed air of a high pressure is conveyed from the compressed air source 35 to the supply tank 1 via the first tube 9.

This causes the activator in the supply tank 1 to be pumped to the connecting tube 7 and the nozzle head 3 and the activator is spouted from the nozzle 25 of the nozzle plate 24.

Specifically, the pressure of the compressed air is preferably not less than 0.008 MPa and not more than 0.040 MPa. When the air pressure is less than 0.008 MPa, the variation in the spouting quantity becomes large, and when it is more than 0.040 MPa, damaging of the coating film surface due to the coating pressure is likely to take place.

Under the above described condition, by moving the nozzle head 3 while keeping the activator to flow down in a brush-like form from the nozzle head 3 onto one end to the other end of the transfer sheet 101, the activator is coated onto the transfer sheet 101 thereby activating the transfer sheet 101.

Moreover, in the present embodiment, in the step of coating the activator onto the transfer sheet 101 to activate the same (S403), the activator is coated only onto the inner part of the transfer sheet 101 excepting its peripheral edge.

As a practical method of coating the activator onto the inner part of the transfer sheet 101 excepting its peripheral edge is implemented by configuring such that the length over which the nozzles 25 of the nozzle head 3 are aligned is smaller than the width of the transfer sheet 101, and by controlling the position of the nozzle head 3 moving above the transfer sheet 101 and the timing of spouting the activator. In this way, it is possible to keep the peripheral edge of the transfer sheet un-coated with the activator without using a shutter or a sealed plate.

Moreover, the above described method does not exclude a method of providing a shutter beneath the nozzle head and controlling the interruption timing of the spouted activator, or a method of providing a shield plate above the peripheral edge of the transfer sheet before coating the activator.

As to the width of the peripheral edge onto which the activator is not coated, when the width is too small, the coating film layer will dissolve after the activator is coated thereby degrading the effect of restricting the phenomenon that the transfer sheet spreads on the water surface, and therefore the width of the peripheral edge onto which the activator is not coated is preferably not less than 5 mm.

Moreover, in the second transfer method, except the method of coating the activator in the step of activating, each step described in the above mentioned first transfer method is carried out in a like manner.

Thus, it becomes possible to coat the activator containing no air bubble onto the transfer sheet 101 thereby preventing transfer defects.

Moreover, termination of coating is effected by closing the first open-close valve 2.

FIG. 8 shows the third step following the above described second step.

After the second step, that is, after the completion of coating of the activator, the first open-close valve 2 remains to be closed as described above. Then, the supply of compressed air to the supply tank 1 is terminated and the third open-close valve 6 is closed so that compressed air is conveyed from the compressed air source 35 to the storage tank 5 via the second air valve 34 and the second tube 10.

This third process step causes the activator in the storage tank 5 to be conveyed to the supply tank 1 through the connecting tube 7 and the third open-close valve 6, and thus it is possible to recover the liquid which has been conveyed to the storage tank 5 in the first step.

In this way, it becomes possible to coat the activator containing no air bubble onto the transfer sheet 101, and suppress the usage amount of the activator at a low level. Moreover, the first tube 9 of pressurizing circuit is provided with a first air valve, and the second tube with a second air valve.

### Example 1

More specific examples of the transfer method according to the present invention will be described.

First, as the transfer sheet 101, there was prepared a sheet which was formed by applying a coating agent made up of a mixture of 100 parts by weight of acrylic urethane oligomer, 15 parts by weight of acrylic monomer, and 20 parts by weight of isopropyl alcohol by a roller coat method on one side of the base material 102 made up of a 40 μm thick polyvinyl alcohol resin film, and by drying it by a hot blast at 80° C. to form a surface protection layer 103 of about 30 μm thick and made of an ionizing radiation curable resin.

Next, the transfer steps will be described.

First, as shown in FIG. 9(a), the transfer bath 11 was filled with water W of a temperature of 30° C.

Next, as shown in FIG. 9(b), the transfer sheet 101 prepared as described above was floated on the water surface of the transfer bath 11, with the color layer 104 on the upside.

Immediately thereafter, as shown in FIG. 9(c), the cover 12 made up of an aluminum plate of about 1 mm thickness was placed on the frame of the transfer bath 11 so that the transfer sheet 101 was covered from above. Moreover, the amount of the water W in the transfer bath 11 was adjusted in advance so that the distance between the cover 12 and the transfer sheet 101 is within 5 to 10 mm.

The transfer sheet 101 was floated on the water surface, and in 120 seconds thereafter, the cover 12 was removed as shown in FIG. 9(d), and then as shown in FIG. 9(e), an activator 14 made up of a combined solvent of butyl acetate, isopropyl alcohol, butylcarbitol acetate, ethyl cellosolve, and toluene is spouted from the nozzle head 3 according to the embodiment 2 so that about 28 g/m² of activator 14 was coated onto the color layer 104 of the transfer sheet 101.

Immediately after the activator was coated, as shown in FIG. 9(f), a cover 12 of a plate thickness of about 1 mm was placed as a cover on the frame of the transfer bath 11 so that the transfer sheet 101 was covered from above. Moreover, as with FIG. 3(c), the amount of the water W in the transfer bath 11 was adjusted in advance such that the distance between the cover 12 and the transfer sheet 101 is 5 to 10 mm.

Next, as shown in FIG. 9(g), a transfer target 15 made up of an ABS (acrylonitrile, butadiene, and styrene) resin plate of 5 mm thickness was placed above the cover 12 and was made to descend at a speed of 5 mm/sec.

Next, as shown in FIG. 9(h), the cover 12 was removed when the distance between the transfer target 15 and the cover 12 becomes 10 mm so that the transfer target 15 and the cover 12 do not come into contact. Next, as shown in FIG. 9(i), the transfer target 15 was further descended so that the transfer sheet 101 is extended over and brought into close contact with the surface of the transfer target 15.

Then, the transfer target 15, over which surface the transfer sheet 101 was extended and with which surface it was in close contact, was withdrawn from the water and, as shown in FIG. 9(j), fresh water of 25° C. was spouted from a slit nozzle 16, which had a slit width of 0.6 mm and a length of 200 mm, thereby washing the base material 102 made up of a polyvinyl alcohol resin film in the transfer sheet 101 so as to wash it away by liquid pressure.

Table 1 below shows the calculated values of kinetic energy of the fresh water 17 when it hits the surface of the transfer target 15 and observation results of the damage condition of the coating film surface due to the water pressure, for arbitrary set values of the amount of flow of fresh water 17 spouting from the slit nozzle 16 and the distance between the slit nozzle 16 and the transfer target 15.

TABLE 1

| | | Amount of water flow (L/min) | | | | |
|---|---|---|---|---|---|---|
| | | 6 | 9.2 | 12.1 | 14.5 | 16.6 |
| Distance between | 5 | 0.040 | 0.133 | 0.295 | 0.502 | 0.749 |
| nozzle and ABS | | ∘ | ∘ | ∘ | ∘ | x |
| resin plate (mm) | 10 | 0.045 | 0.140 | 0.305 | 0.514 | 0.762 |
| | | ∘ | ∘ | ∘ | ∘ | x |
| | 50 | 0.084 | 0.200 | 0.384 | 0.608 | 0.871 |
| | | ∘ | ∘ | ∘ | ∘ | x |
| | 100 | 0.133 | 0.275 | 0.482 | 0.727 | 1.006 |
| | | ∘ | ∘ | ∘ | x | x |
| | 200 | 0.231 | 0.426 | 0.680 | 0.964 | 1.278 |
| | | ∘ | ∘ | ∘ | x | x |

Upper case values in the table: Kinetic energy of fresh water
Lower case symbols: ∘: Without surface damage, x: With surface damage

The kinetic energy was derived from the following equation (formula 1).

$$Kinetic energy = \frac{1}{2} {mv}^{2} + m g h ( kg \cdot {i}^{2} / {s}^{2} ) \qquad [ Formula 1 ]$$

m: Amount of water flow spouted per one second (kg/s)
v: Flow velocity (m/s)
g: Gravitational acceleration (m/s²)
h: Distance between nozzle and ABS resin plate (m)

Moreover, flow velocity v was calculated from nozzle opening area: 0.6×200×10⁻⁶ (m²) and the volume of water spouted per one second: m×10⁻³ (m³/s) by the following equation (formula 2).

$$v = \frac{Volume of water spouted per one second}{Nozzle opening area} = \frac{m \times {10}^{3}}{0.6 \times 200 \times {10}^{- 6}} = \frac{m \times {10}^{3}}{0.6 \times 200} = 1000 m / 0.6 / 200 \qquad [ Formula 2 ]$$

Since when the kinetic energy of fresh water 17 became more than 0.68 kg·m²/s², a damage on the surface of the coating film took place thereby degrading the image clarity, the samples washed under the condition that the kinetic energy is not more than 0.68 kg·m²/s² were used in the following steps.

After the washing, the transfer target 15 was dried to get a liquid-pressure transfer plate 18 including at its surface a coating film layer 105 made up of an ionizing radiation curable resin.

Next, the liquid-pressure transfer plate 18 was passed through below an ozone-type high-pressure mercury-vapor lamp in such a way that the coating film layer of the ionizing radiation curable resin in the liquid-pressure transfer plate 18 be the irradiation surface, and was subjected to irradiation of ionizing radiation for 10 seconds to cure the coating film layer.

The image clarity of resulting surface of the liquid-pressure transfer plate 18 was measured by an Image Clarity Meter ICM-1T (optical comb width: 1 mm, 45° reflection) manufactured by SUGA TEST INSTRUMENTS Co., Ltd. In the image clarity measurement instrument, the measurement result of the image clarity is indicated by a numeric value from 0 to 100, where the value becomes larger as the image clarity becomes higher. The measurement result showed a numeric value of 63.

Moreover, as the result of observing the generation of foreign matter defects for 10 pieces of liquid-pressure transfer plates 18 of 150×200 mm size, there was no foreign matter defect generated.

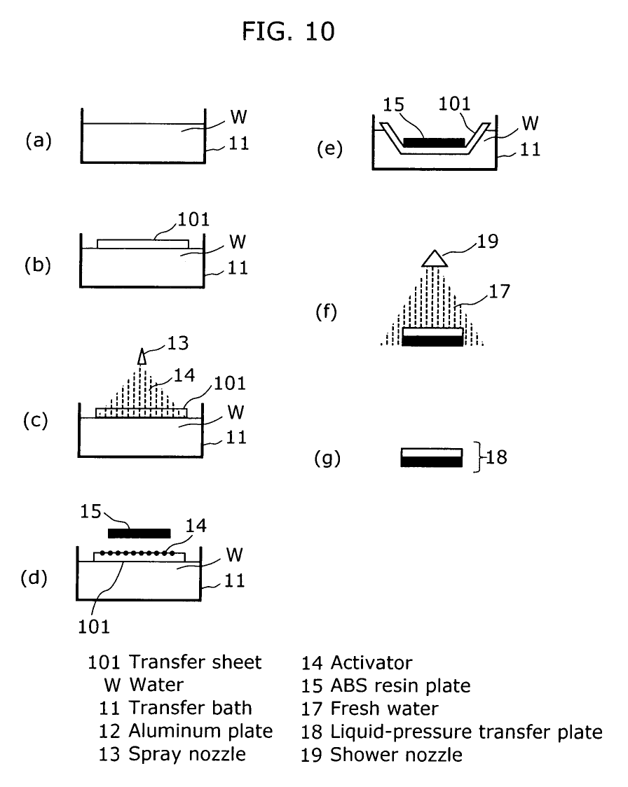

Now, a comparative example for the transfer method by liquid pressure according to the embodiment 1 will be described with reference to a conventional transfer method shown in FIG. 10. FIGS. 10(a) to (g) are sectional views showing the process steps of a conventional transfer method by liquid pressure.

FIG. 10(a) shows a transfer bath 11 filled with water W of 30° C. and, as shown in FIG. 10(b), a transfer sheet 101 was floated on the water surface of the transfer bath 11 such that the color layer 104 is on the upside.

In 120 seconds after the transfer sheet 101 was floated on the water surface, as shown in FIG. 10(c), an activator 14 made up of a combined solvent of butyl acetate, isopropyl alcohol, butylcarbitol acetate, ethyl cellosolve, and toluene was spouted from a spray nozzle 13 so that about 28 g/m² of activator 14 was coated onto the color layer 104 of the transfer sheet 101.

Then, as shown in FIGS. 10(d) and (e), a transfer target 15 of the same material and 5 mm plate thickness was placed above the transfer sheet 101 and was made to descend at a speed of 5 mm/s so that the transfer sheet 101 spreads over and brought into close contact with the surface of the transfer target 15.

Next, the transfer target 15, over which surface the transfer sheet 101 is extended and with which surface it is in close contact, was withdrawn from the water and as shown in FIG. 10(f), fresh water 17 of 25° C. was spouted by means of a shower nozzle 19 so that the transfer sheet base material 102 made up of polyvinyl alcohol resin film in the transfer sheet 101 was removed.

Further, by drying, a liquid-pressure transfer plate 18 in which the coating film layer 105 is made up of an ionizing radiation curable resin is obtained.

Next, the liquid-pressure transfer plate 18 was passed under an ozone-type high-pressure mercury-vapor lamp, with the coating film layer of the ionizing radiation curable resin as the surface to be irradiated, and was subjected to irradiation of ionizing radiation for 10 seconds to cure the coating film layer.

The image clarity of resulting surface of the liquid-pressure transfer plate 18 was measured by an Image Clarity Meter ICM-1T (optical comb width: 1 mm, 45° reflection) manufactured by SUGA TEST INSTRUMENTS Co., Ltd. and the resulting numerical value was 32.

Moreover, as the result of observing the generation of foreign matter defects for 10 pieces of liquid-pressure transfer plates 18 of 150×200 mm size, there were 25 spots of foreign matter defects generated.

### Example 2

Next, the performance difference due to the difference in the coating conditions of the activator 14 was investigated.

In the example 2, a similar transfer sheet 101 to that of the above described example 1 was used and the transfer method by liquid pressure is the same as that of the above described example 1 except the coating method of the activator 14. Therefore, the description of the process steps except for the coating method of the activator will be omitted.

A transfer sheet 101 is floated, with the color layer 104 on the upside, on the water surface of the transfer bath 11 filled with water W of 30° C.

By moving the nozzle head 3 above the transfer sheet 101 while applying air pressure to the supply tank 1 of the liquid coating apparatus 30 and pumping the activator 14 so that the activator flows down in a brush-like form from multiple nozzles 25, 30 g/m² of activator 14 was coated onto the transfer sheet 101.

The pore depth of the nozzle plate 24, the pore diameter of the nozzle 25, and the air pressure applied to the activator 34 were varied, and the presences and absences of liquid dripping, the variation in the spouting quantity of the activator 14, and the damage on the coating film surface were visually observed, the results of which are shown in Tables 2 and 3.

TABLE 2

| | | Pore length mm | | | | | |
|---|---|---|---|---|---|---|---|
| | | 0.04 | 0.05 | 0.1 | 0.2 | 0.3 | 0.32 |
| Pore diameter | 0.015 | Variation | Variation | Variation | Variation | Variation | Variation |
| of through | | in | in | in | in | in | in |
| pore mm | | coating | coating | coating | coating | coating | coating |
| | 0.02 | Liquid | Good | Good | Good | Good | Variation |
| | | dripping | | | | | in |
| | | | | | | | coating |
| | 0.05 | Liquid | Good | Good | Good | Good | Variation |
| | | dripping | | | | | in |
| | | | | | | | coating |
| | 0.1 | Liquid | Good | Good | Good | Good | Variation |
| | | dripping | | | | | in |
| | | | | | | | coating |
| | 0.15 | Liquid | Good | Good | Good | Good | Variation |
| | | dripping | | | | | in |
| | | | | | | | coating |
| | 0.16 | Liquid | Liquid | Liquid | Liquid | Liquid | Variation |
| | | dripping | dripping | dripping | dripping | dripping | in |
| | | | | | | | coating |

Table 2 shows the results when the air pressure to be applied to the activator 14 was kept constant (fixed at 0.03 MPa), and the pore depth and the pore diameter of the nozzle 25 were varied. When the pore depth is less than 0.05 mm, liquid dripping of the activator took place, and when it is more than 0.3 mm, the variation in the spouting quantity became larger. Moreover, when the pore diameter is less than 0.02 mm, the variation in the spouting quantity became larger, and when it is more than 0.15 mm, liquid dripping of the activator took place.

TABLE 3

| | | Pore length mm | | | |
|---|---|---|---|---|---|
| | | 0.05 | 0.1 | 0.2 | 0.3 |
| Coating | 0.005 | Variation in | Variation in | Variation in | Variation in |
| pressure | | coating | coating | coating | coating |
| MPa | 0.008 | Good | Good | Good | Good |
| | 0.015 | Good | Good | Good | Good |
| | 0.02 | Good | Good | Good | Good |
| | 0.03 | Good | Good | Good | Good |
| | 0.04 | Good | Good | Good | Good |
| | 0.05 | Surface | Surface | Surface | Surface |
| | | damage | damage | damage | damage |

Table 3 shows the results when the pore diameter of the nozzle 25 was kept constant (φ: 0.007 mm constant) and the pore depth and the air pressure applied to the activator were varied. When the air pressure was less than 0.008 MPa, variations in the spouting quantity took place and when it is more than 0.02 MPa, damages of the coating film surface due to the coating pressure took place.

The activator 14 was applied with an air pressure of 0.03 MPa by using the nozzle plate 24 of 0.1 mm pore depth and 0.07 mm pore diameter to fabricate a liquid transfer plate 18. At that moment, the timing of coating the activator 14 was controlled so that the activator is not coated onto 10 mm or more of the peripheral edge of the transfer sheet 101.

The image clarity of resulting surface of the liquid-pressure transfer plate was measured by a Image Clarity Meter ICM-1T (optical comb width: 1 mm, 45° reflection) manufactured by SUGA TEST INSTRUMENTS Co., Ltd. and the resulting numerical value was 69.

Moreover, the occurrences of a foreign matter defect and a surface rupture of a coating film, and a break or a distortion of print pattern were observed on the 10 pieces of liquid-pressure transfer plates 18 of 150×200 mm size. As the result, there have not been observed any of a foreign matter defect and a surface rupture of coating film, and a break or a distortion of print pattern.

Industrial Applicability

The transfer method of the present invention is useful as a method of obtaining a coating film having enhanced adhesion and image clarity, having no external defects such as a foreign matter defect, a surface rupture, a break of print pattern, a distortion of print pattern, and having high aesthetic quality, and of forming a coating film on the surface of various formed bodies.

1. A transfer method comprising:
a step of floating a transfer sheet on a water surface of a transfer bath so as to swell the transfer sheet, the transfer sheet having a base material layer and a coating film layer;
a step of coating an activator onto the transfer sheet to activate the transfer sheet;
a step of immersing a transfer target into the transfer bath from above the transfer sheet to transfer the transfer sheet;
a step of washing away the base material layer with water;
a step of drying the transfer target onto which the coating film has been transferred; and
a step of curing the coating film which has been transferred onto the transfer target,
wherein said step of coating an activator onto said transfer sheet to activate the transfer sheet includes
a step of coating the activator onto the transfer sheet by ejecting the activator from a nozzle head having multiple nozzles and moving the nozzle head above the transfer sheet, the activator being pumped at a pressure of not less than 0.008 MPa and not more than 0.040 Mpa.

2. The transfer method according to claim 1,
wherein said step of floating a transfer sheet on a water surface of a transfer bath to swell the transfer sheet includes
a step of placing a cover above the transfer sheet after floating the transfer sheet on the water surface of the transfer bath.

3. The transfer method according to claim 1,
wherein said transfer method further comprises:
a step of pumping the activator at a pressure lower than the pressure in said step of coating the activator, and discharging air from the nozzle head before said step of coating the activator; and
a step of recovering the activator used in said step of discharging the air, and conveying the activator to the supply tank.

4. The transfer method according to claim 1,
wherein said step of coating an activator onto the transfer sheet includes
a step of coating the activator onto the inner part of the transfer sheet excepting a peripheral edge of the transfer sheet.

5. A liquid coating apparatus used in a transfer method, said liquid coating apparatus comprising:
a nozzle head provided with a plurality of nozzles;
a through passage provided inside said nozzle head and through which liquid is passed;
a supply tank for holding liquid to be pumped;
a storage tank for storing the liquid which has passed through said through passage;
a first open-close valve provided in a first flow passage which connects said supply tank and said nozzles;
a second open-close valve provided in a second flow passage which connects said storage tank and said nozzles; and
a third open-close valve provided in a third flow passage which connects said storage tank and said supply tank,
wherein units of said nozzles, said supply tank, and said storage tank are connected to form a closed flow passage,
said nozzle head being provided with said plurality of nozzles each of which has a pore depth of not less than 0.05 mm and not more than 0.3 mm, and a pore diameter of not less than 0.02 mm and not more than 0.15 mm.

6. The liquid coating apparatus used in the transfer method according to claim 5,
wherein said nozzle head includes a through passage which is connected with the nozzles and is provided with an ejection port other than the nozzles.

7. The liquid coating apparatus used in the transfer method according to claim 6, said liquid coating apparatus comprising:
a supply tank for holding liquid to be pumped;
a storage tank for storing the liquid which has passed the ejection port of the through passage; and
a connecting passage for conveying liquid from said supply tank to said storage tank.

8. The liquid coating apparatus used in the transfer method according to claim 5, said liquid coating apparatus further comprising
a moving mechanism for moving said nozzle head and a transfer sheet relative to each other.

9. The transfer method according to claim 2,
wherein said transfer method further comprises:
a step of pumping the activator at a pressure lower than the pressure in said step of coating the activator, and discharging air from the nozzle head before said step of coating the activator; and
a step of recovering the activator used in said step of discharging the air, and conveying the activator to the supply tank.

10. The transfer method according to claim 2,
wherein said step of coating an activator onto the transfer sheet includes
a step of coating the activator onto the inner part of the transfer sheet excepting a peripheral edge of the transfer sheet.

11. The transfer method according to claim 3,
wherein said step of coating an activator onto the transfer sheet includes
a step of coating the activator onto the inner part of the transfer sheet excepting a peripheral edge of the transfer sheet.

12. The transfer method according to claim 9,
wherein said step of coating an activator onto the transfer sheet includes
a step of coating the activator onto the inner part of the transfer sheet excepting a peripheral edge of the transfer sheet.

13. The liquid coating apparatus used in the transfer method according to claim 6, said liquid coating apparatus further comprising
a moving mechanism for moving said nozzle head and a transfer sheet relative to each other.

14. The liquid coating apparatus used in the transfer method according to claim 7, said liquid coating apparatus further comprising
a moving mechanism for moving said nozzle head and a transfer sheet relative to each other.
